(19) United States
(12) Patent Application Publication
(10) Pub. No.: US 2006/0253295 A1
(43) Pub. Date: Nov. 9, 2006

(54) Billing apparatus for direct drawing apparatus

(76) Inventors: Kazunari Sekigawa, Nagano-shi (JP); Masatoshi Akagawa, Nagano-shi (JP)

Correspondence Address: MORGAN & FINNEGAN, L.L.P., 3 WORLD FINANCIAL CENTER, NEW YORK, NY, 10281-2101, US

(21) Appl. No.: 11/408,556

(22) Filed: Apr. 20, 2006

(30) Foreign Application Priority Data
Apr. 22, 2005 (JP) 2005-124758

(51) Int. Cl. G06Q 99/00

(52) U.S. Cl. 705/1

(57) ABSTRACT

A billing apparatus, for a direct drawing apparatus in which drawing data generated based on layout design data and necessary for drawing is supplied to a drawing engine in real time during the drawing and, based on the drawing data, the drawing engine forms a drawing pattern on a drawing target moving relative to the drawing engine, comprises: counting means for counting the number of frames in the drawing data supplied to the drawing engine, one drawing data frame being constructed by packetizing data of an amount necessary for a drawing head in the drawing engine to perform one drawing operation; and billing charge determining means for determining a billing charge based on the number of frames counted by the counting means.

### BACKGROUND OF THE INVENTION

1. Field of the Invention

The present invention relates to a billing apparatus for a direct drawing apparatus which draws a pattern directly on a drawing target.

2. Description of the Related Art

Generally, a wiring pattern on a wiring substrate is formed by applying a photoresist over the substrate and exposing the photoresist to a desired pattern based on wiring pattern layout design data, and then developing and printing the desired pattern on the substrate, followed by etching. In the exposure process, a photomask is usually used.

On the other hand, a patterning method based on direct drawing that does not use photomasks has been developed in recent years and has been implemented commercially. According to this method, as corrections or transformations (auto scaling) to correct for the expansion, shrinkage, distortion, displacement, etc. of the substrate can be applied to the drawing pattern in real time or in advance at the drawing data generation stage, remarkable improvements can be achieved in the manufacturing accuracy, the manufacturing yield, a reduction in the delivery time, and a reduction in the manufacturing cost.

Examples of the patterning method based on direct drawing include a method that forms an exposure pattern by maskless exposure using a Digital Micromirror Device (DMD), an electron beam exposure machine, or the like, and a method that uses an inkjet drawing technique. In the prior art, one example of the patterning method based on maskless exposure that uses the DMD is disclosed in Japanese Unexamined Patent Publication No. 10-112579. According to the technique disclosed therein, when directly exposing the photoresist formed on an exposure target substrate, pattern data corresponding to the pattern to be exposed is generated and this pattern data is applied to the Digital Micromirror Device (DMD), causing each of its tiny mirrors (micromirrors) to tilt according to the pattern data; by thus changing the direction of the light reflected by each micromirror on the DMD as needed, the light is projected onto the resist on the exposure target substrate to form an exposure pattern that matches the pattern data.

FIG. 3 is a diagram schematically showing a conventional maskless exposure system. The maskless exposure system 100 comprises an exposure apparatus 101 and a computer 102 connected to the exposure apparatus 101. The computer 102 supplies exposure data to the exposure apparatus 101 and controls the exposure apparatus 101. The exposure apparatus 101 comprises a stage 110 on which an exposure target substrate 151 is mounted, and an exposing means 111 which moves in relative fashion over the surface of the exposure target substrate 151 in a direction indicated by an arrow in the figure. The exposing means 111 is equipped with one or more exposure engines (not shown) which are each assigned an area to be exposed on the surface of the exposure target substrate 151 and perform exposure operations in parallel. In each exposure engine, a plurality of exposure devices (not shown) for modulating light sources are arranged in a two-dimensional array. For example, when the maskless exposure system 100 is of the type that uses the DMD, the micromirrors of the DMD correspond to the exposure devices.

FIG. 4 is a diagram showing the operating principle of the conventional maskless exposure apparatus. The exposing means 111, which moves in relative fashion over the surface of the exposure target substrate 151, is equipped with a plurality of exposure engines #1 to #N (reference numeral 130) (N is a natural number) arranged in a direction orthogonal to the direction of relative movement of the exposure target substrate 151. A stage controller 129 causes the exposure target substrate 151 to move at speed Vex relative to the exposure engines #1 to #N (reference numeral 130).

The exposure target substrate 151 is divided in a virtual manner into N areas called the “strips #1 to #N” (reference numeral 132). The exposure engines #1 to #N (reference numeral 130), while moving relative to the exposure target substrate 151 at speed Vex, perform exposure on their respectively corresponding strips #1 to #N (reference numeral 132). Here, the length of the exposure target substrate 151 in the direction of the relative movement, that is, the length of each of the strips #1 to #N (reference numeral 132), is denoted by L_{Y} (hereinafter referred to as the “strip length”). Likewise, the length of the exposure target substrate 151 in the direction perpendicular to the direction of the relative movement (hereinafter referred to as the “width of the exposure target substrate”) is denoted by L_{X}.

The area that each of the exposure engines #1 to #N (reference numeral 130) can expose at a time is limited. In the direction orthogonal to the direction of relative movement of the exposure target substrate 151, the width W of the area that each exposure engine can expose corresponds to the width W of each of the strips #1 to #N (reference numeral 132). Here, the relation L_{X}=N×W holds. The larger the width in the orthogonal direction that a single DMD can expose, the smaller the number of DMDs needed to cover the entire exposure range of the exposure target substrate, and thus the cost of the exposure apparatus itself can be reduced and the productivity increases.

On the other hand, the length of the area on the exposure target substrate 151 that each exposure engine can expose in the direction of the relative movement is shorter than the strip length L_{Y}. Accordingly, each of the strips #1 to #N (reference numeral 132) is subdivided in a virtual manner into M “exposure blocks (i, j) (here, M is a natural number, while 1≦i≦N and 1≦j≦M)” (reference numeral 133), and each exposure engine exposes these exposure blocks (i, j) in sequence. When the length of each exposure block (i, j) in the direction of the relative movement is denoted by ΔY, the relation L_{Y}=M×ΔY holds between the strip length L_{Y} and the length ΔY of each exposure block (i, j) in the direction of the relative movement.

The exposure data supplied to the exposure engines #1 to #N (reference numeral 130) is typically data based on bitmap data. Since the amount of bitmap data is very large, generating and storing the bitmap data prior to exposure would not be preferable as it would consume a large amount of memory resources. Therefore, to conserve the memory resources, for each of the exposure engines #1 to #N (reference numeral 130) the exposure data in bitmap form is generated based on layout design data (typically, Gerber format data) in real time during the exposure process by dividing the data in a virtual manner for each of the exposure engines #1 to #N (reference numeral 130), that is, for each of the strips #1 to #N (reference numeral 132), and for each exposure block (i, j) in each of the strips #1 to #N (reference numeral 132); the thus generated data is first temporarily stored in memory, and then sequentially supplied to each corresponding one of the exposure engines #1 to #N (reference numeral 130). Accordingly, each of the exposure engines #1 to #N (reference numeral 130) performs maskless exposure based on the exposure data of bitmap form supplied for each exposure block (i, j).

The light sources in each exposure engine are switched on and off independently of each other once every predetermined period of time. This predetermined period of time is called a “frame”, and the switching frequency is called the frame rate. That is, the exposure engine can update the illumination pattern, of the light projected to the exposure target substrate, once every frame. In other words, each exposure head in the exposure engine can perform one exposure using the same illumination pattern during one frame period. For example, when the exposure apparatus is of the type that uses a DMD, the angular switching rate of each micromirror (i.e., the modulation rate of the DMD) corresponds to the frame rate, and the angle of each micromirror is controlled for each frame.

The exposure data to be supplied to each exposure engine is packetized (encapsulated) each time the data of an amount necessary for one exposure is generated, and the data thus packetized for each frame is sequentially supplied to the exposure engine.

As described above, since the amount of the exposure data, in bitmap form, is very large, to conserve memory resources the exposure data is generated based on layout design data in real time at a prescribed frame rate for each exposure block during the exposure process, and the generated exposure data is supplied to the corresponding exposure engine. The exposure data is generated by a data generation board (DGB). The exposure data “produced” for each exposure block in real time is sequentially “consumed” for each exposure block at the prescribed frame rate by the corresponding exposure engine.

An example in which such a direct exposure system is connected to a local area network or an external network, and in which the user side is controlled from the vendor side via the network, is disclosed in Japanese Unexamined Patent Publication No. 2002-57101.

On the other hand, Japanese Unexamined Patent Publication No. 2003-142382 discloses a system in which an exposure apparatus at the user side is connected to a management apparatus such as a computer at the vendor side and controlled by the management apparatus via a network, wherein when a processing algorithm is downloaded into the exposure apparatus, the management apparatus bills the user for the service.

Further, Japanese Unexamined Patent Publication No. 2003-318085 discloses a system in which a device manufacturing apparatus at the user side is connected to a management apparatus such as a computer at the vendor side and is controlled by the management apparatus via a network, wherein the network control is performed to provide field support and maintenance services. This system bills charges for the field support and manages consumable parts of the device manufacturing apparatus via the network.

As earlier described, according to the direct drawing apparatus that does not use photomasks, as corrections for the expansion, shrinkage, distortion, displacement, etc. of the drawing target can be applied to the drawing pattern in real time or in advance at the drawing data generation stage, remarkable improvements can be achieved in such aspects as an improvement in the manufacturing accuracy, an improvement in the manufacturing yield, a reduction in the delivery time, and a reduction of the manufacturing cost.

However, the direct drawing apparatus is only a recent development and has not yet found widespread use in industry and, at the present time, the initial investment cost required to introduce the direct drawing apparatus is very high. Therefore, for printed circuit board manufacturers and IC package manufacturers, it is not financially easy to install such apparatus; on the other hand, for the manufacturers (or vendors) of the direct drawing apparatus, economies of scale cannot be readily relied upon to reduce the cost, because the buyers of the direct drawing apparatus are limited in number.

A direct drawing apparatus that does not use photomasks has the potential of bringing about dramatic changes throughout the semiconductor industry because the apparatus has advantages not found in conventional exposure apparatus that use photomasks. However, as described above, the price and cost problems have impeded the widespread use of the apparatus.

Further, if the direct drawing apparatus is installed at all, the high initial investment cost of the apparatus has to be recovered by transferring some of the cost to the products manufactured using the direct drawing apparatus. As a result, the products manufactured using the direct drawing apparatus are not cost competitive because of their high price compared with the products manufactured using the conventional exposure apparatus that uses photomasks. This has been one of the factors that discourage printed circuit board manufacturers and IC package manufacturers from installing the direct drawing apparatus.

In view of the above problem, it is an object of the present invention to provide a billing apparatus for a direct drawing apparatus which draws a pattern directly on a drawing target, wherein provisions are made to make it easy for the user to install the direct drawing apparatus.

### SUMMARY OF THE INVENTION

To achieve the above object, according to the present invention, the direct drawing apparatus is leased to the user, and an appropriate billing scheme is constructed, thereby minimizing the initial investment cost required to introduce the direct drawing apparatus, while ensuring the vendor (or manufacturer) of the direct drawing apparatus a secure way to collect the leasing fees without fail.

FIG. 1 is a basic functional block diagram of a billing apparatus for a direct drawing apparatus according to the present invention. According to the present invention, the billing apparatus 1 for the direct drawing apparatus 2, in which drawing data generated based on layout design data and necessary for drawing is supplied to a drawing engine 3 in real time during the drawing and, based on the drawing data, the drawing engine 3 forms a drawing pattern on a drawing target moving relative to the drawing engine 3, comprises: a counting means 11 for counting the number of frames in the drawing data supplied to the drawing engine 3, one drawing data frame being constructed by packetizing data of an amount necessary for a drawing head in the drawing engine 3 to perform one drawing operation; and a billing charge determining means 12 for determining a billing charge based on the number of frames counted by the counting means 11. Here, the billing charge determining means 12 may determine the billing charge by considering various billing parameters in addition to the number of frames.

### BRIEF DESCRIPTION OF THE DRAWINGS

The present invention will be more clearly understood from the description as set below with reference to the accompanying drawings, wherein:

FIG. 1 is a basic functional block diagram of a billing apparatus for a direct drawing apparatus according to the present invention;

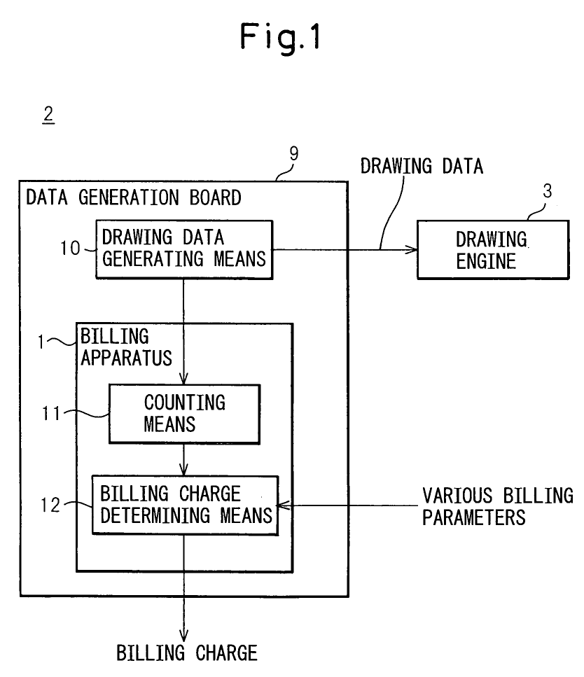

FIG. 2 is a block diagram for explaining a billing apparatus according to an embodiment of the present invention;

FIG. 3 is a diagram schematically showing a conventional maskless exposure system; and

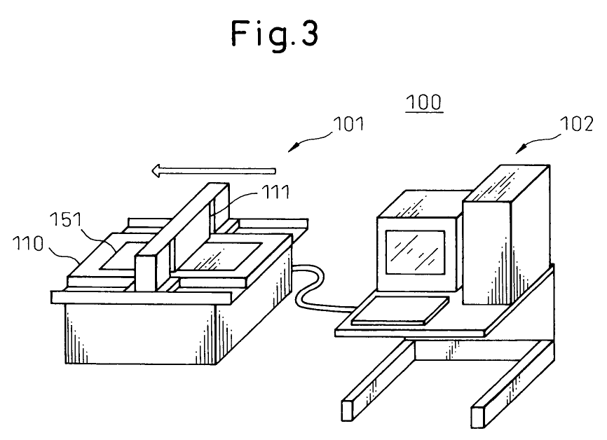

FIG. 4 is a diagram showing the operating principle of the conventional maskless exposure apparatus.

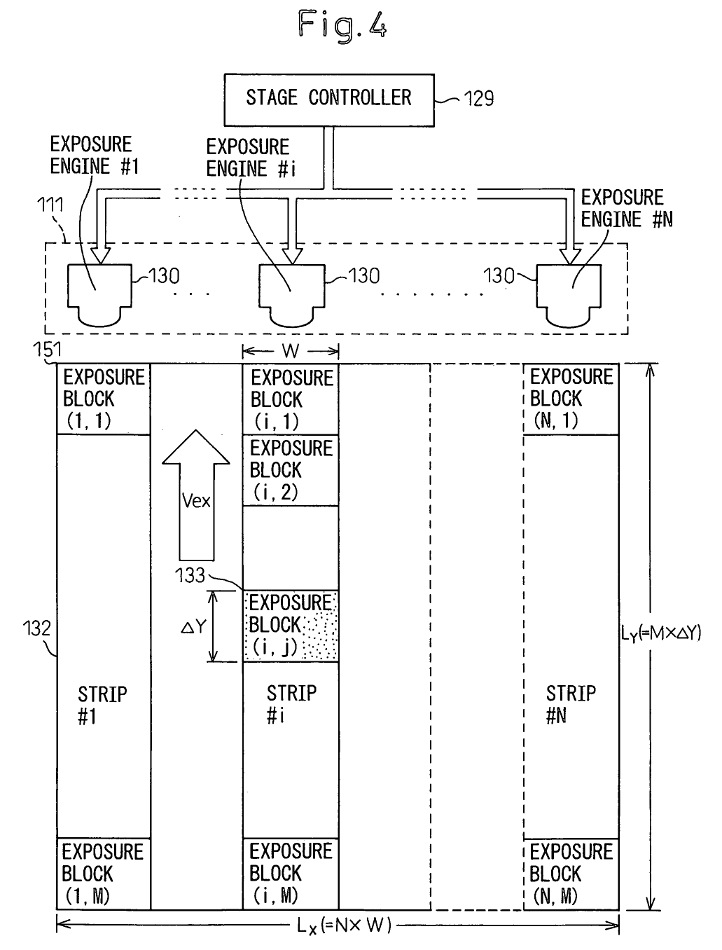

### DESCRIPTION OF THE PREFERRED EMBODIMENTS

An embodiment of the present invention will be described for the case where the direct exposure apparatus is a maskless exposure apparatus which forms a desired exposure pattern by projecting light from a plurality of exposure devices onto desired spots on an exposure target substrate moving relative to the exposure devices, the plurality of exposure devices being arranged along the direction of the relative movement. In the present embodiment, a DMD (Digital Micromirror Device) is used as an exposure engine in the maskless exposure apparatus. More specifically, in the maskless exposure apparatus of the present embodiment, exposure data generated based on bitmap data and necessary for exposure is supplied to the DMD in real time during the exposure and, based on the exposure data, the DMD forms a drawing pattern on the exposure target moving relative to the DMD.

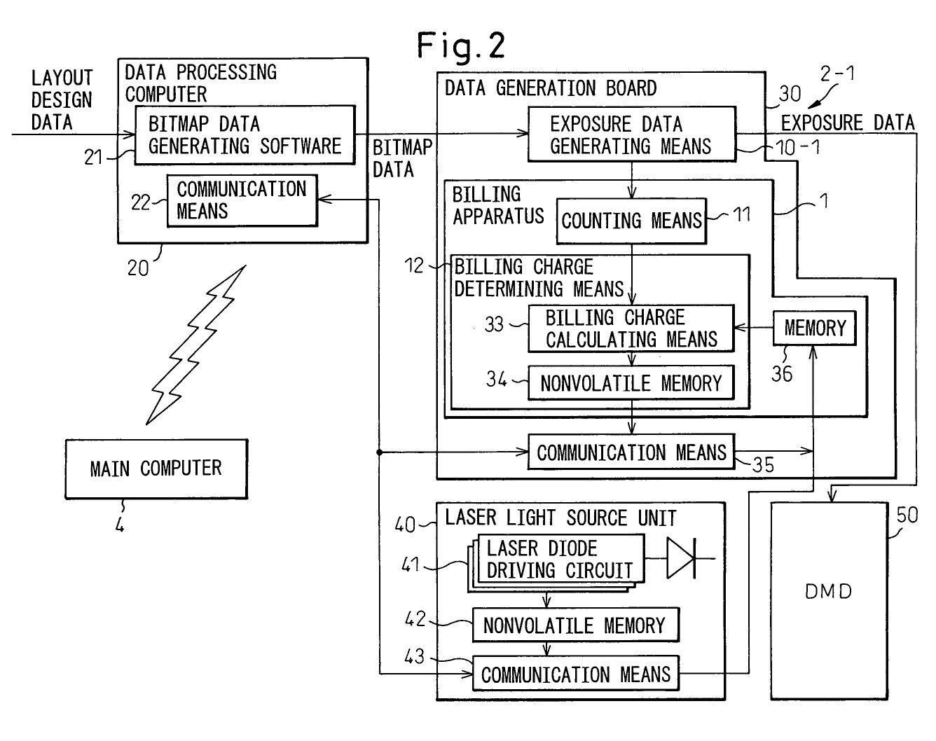

FIG. 2 is a block diagram for explaining a billing apparatus according to the embodiment of the present invention. The maskless exposure apparatus 2 in this embodiment comprises the following component elements.

A data processing computer 20 for performing data processing in the maskless exposure apparatus 2-1 comprises bitmap generating software 21 and a communication means 22. The data processing computer 20 takes layout design data (typically, Gerber format data) as an input, and generates bitmap data by using the bitmap generating software 21 and, if necessary, by applying corrections such as auto scaling. The generated bitmap data is sent to an exposure data generating means 10-1 accommodated on a data generation board 30.

Based on the bitmap data, the exposure data generating means 10-1 accommodated on the data generation board 30 generates exposure data at a prescribed frame rate in real time during the exposure. The generated exposure data is sent to the DMD (reference numeral 50).

The billing apparatus 1 according to the present embodiment is accommodated on the data generation board 30. The billing apparatus 1 comprises a counting means 11 and a billing charge determining means 12. The billing charge determining means 12 comprises a billing charge calculating means 33 for calculating a billing charge and a nonvolatile memory 34 in which the billing charge data calculated by the billing charge calculating means 33 is stored in nonvolatile fashion together with the time of day. Here, the billing charge determining means 12 may determine the billing charge based not only on the number of frames but also on various billing parameters, and a memory 36 is provided for storing the various billing parameters. Specific examples of the billing parameters will be described later.

Light for illuminating the micromirrors on the DMD 50 is produced by a laser light source unit 40 comprising an array of laser diodes. In the present embodiment, the laser light source unit 40 comprises laser diode driving circuits 41 provided one for each laser diode, a nonvolatile memory 42 in which the integrated value of light energy produced by each laser diode is stored in nonvolatile fashion together with the time of day of the integration, and a communication means 43.

A communication means 35 and the communication means 43 communicate with the communication means 22 and the memory 36.

A main computer 4 is connected to the data processing computer 20 via the Internet, a wireless link, or a telephone line or the like, and enables remote monitoring or remote operations to be performed for the calculation of billing charges, the prediction of remaining life of the laser light source unit, etc.

Next, a description will be given of the operation of the billing apparatus 1 for the maskless exposure apparatus 2-1.

The data processing computer 20 for performing data processing in the maskless exposure apparatus 2-1 receives the layout design data (typically, Gerber format data), and generates the data (typically, bitmap data) to be input to the data generation board 30 by executing processing, in real time, by the bitmap generating software 21 and, if necessary, by applying corrections such as auto scaling.

The exposure data generating means 10-1 accommodated on the data generation board 30 generates one frame of exposure data by packetizing the received bitmap data into data of an amount necessary for the exposure devices on the DMD 50 to perform one exposure, that is, data of an amount necessary to cause the micromirrors on the DMD 50 to change orientation once. The exposure data generated by the exposure data generating means 10-1 is sent to the DMD 50.

The counting means 11 in the billing apparatus 1 counts the number of frames in the exposure data generated by the exposure data generating means 10-1.

The billing charge calculating means 33 in the billing charge determining means 12 calculates the billing charge based on the number of frames counted by the counting means 11. In one specific example, the calculation is performed by “incrementing the billing charge by 1 for every 10 million frames counted.” Here, the number of frames in the exposure data will be examined below. Equation (1) shows the number of exposure data frames, F, necessary to perform exposure along the length defined by a distance L, where L [mm] is the distance over which the exposure target substrate is to be exposed along the direction of the relative movement.

$$F = \frac{1000 L}{S} = \frac{1000 L}{α \cdot r} \qquad ( 1 )$$

That is, the number of frames, F, is determined by dividing the distance L [mm] over which the exposure target substrate is to be exposed along the direction of the relative movement, by a step size S [μm] which defines a distance over which the exposure engine moves relative to the exposure target substrate while the exposure engine performs one exposure using the exposure devices.

Here, the step size S is a parameter dependent on the bitmap resolution r in the layout design data, and is given as S=αr where α is the operating speed coefficient (a dimensionless number) of the data generation board 30. For example, when the bitmap resolution r is 0.5 [μm], if α is set to 1, then the exposure target substrate can be exposed with a resolution of 0.5 [μ] by using the bit map data with the bitmap resolution r=0.5 [μ]. On the other hand, if α is set to 2, for example, the exposure target substrate can be exposed with a resolution of 1.0 [μm] by using the bit map data with the bitmap resolution r=0.5 [μm]. This means that every other bit in the bit map data with the bitmap resolution r=0.5 [μm] is used for exposure. Further, if α is set to 3, for example, the exposure target substrate can be exposed with a resolution of 1.5 [μm] by using the bit map data with the bitmap resolution r=0.5 [μm]. This means that every third bit in the bit map data with the bitmap resolution r=0.5 [μm] is used for exposure. The larger the value of the operating speed coefficient α of the data generation board 30, the lower the exposure resolution, as described above, but the exposure speed increases.

As described above, in the present embodiment, the billing charge is calculated based on the number of frames of exposure data. With the same operating speed coefficient α, exposure can be performed with a higher resolution by increasing the bitmap resolution r but, in this case, the number of frames, F, increases as can be seen from equation (1). On the other hand, when the bitmap resolution r of the bitmap data is held constant, the exposure speed increases as the operating speed coefficient α is larger, but the exposure resolution drops. In this case, the number of frames, F, can be reduced as seen from equation (1). That is, according to the present embodiment characterized by billing based on the number of exposure data frames, a billing scheme such that “the billing charge increases as the resolution increases” can be implemented.

The billing charge calculating means 33 may calculate the billing charge by considering not only the number of frames, as described above, but also various billing parameters. Some of the specific examples of the billing parameters will be described here.

The switching speed of the micromirrors on the DMD 50 is an important parameter that defines not only the mechanical performance of the DMD but also the productivity of the maskless exposure apparatus 2-1. For a DMD capable of high-speed operation, a high-performance data generation board 30 must be provided that is capable of operating at a speed that matches the high switching speed of the micromirrors. When the operating speed of the data generation board 30, that is, the frame rate, is denoted by Fmax [frame/sec], the time T [sec] required to perform exposure along the length defined by the distance L is given by equation (2) below.

$$T = \frac{F}{F max} = \frac{1000 L}{α \cdot r \cdot F max} \qquad ( 2 )$$

From equation (2), it can be seen that the time T required to perform the exposure becomes shorter as the frame rate Fmax of the data generation board 30 increases. That is, the productivity increases as the frame rate Fmax of the data generation board 30 increases. Accordingly, in the present embodiment, the frame rate Fmax of the data generation board 30 is adopted as a billing parameter. That is, the billing charge is set so as to increase as the frame rate Fmax of the data generation board 30 increases. To describe this in a manner similar to the previously given specific example, the calculation is performed, for example, by “incrementing the billing charge by 1 for every 5 million frames counted.”

In a configuration in which the exposure is performed using a plurality of DMDs arranged along a direction orthogonal to the direction of relative movement of the exposure target substrate, the larger the width W [mm] in the orthogonal direction that a single DMD can expose, the smaller the number of DMDs needed to cover the entire exposure range of the exposure target substrate, and thus the cost of the exposure apparatus itself can be reduced and the productivity increases. Accordingly, in the present embodiment, the width W in the orthogonal direction that a single DMD can expose is adopted as a billing parameter. That is, the billing charge is set so as to increase as the exposure width W of each DMD increases. To describe in a manner similar to the previously given specific example, the calculation is performed, for example, by “incrementing the billing charge by 1 for every 5 million frames counted when the exposure width is twice the standard width.” Here, if the plurality of DMDs have different exposure widths, the billing charge may be set for each exposure width.

The decisive difference between the maskless exposure apparatus 2-1 and the conventional exposure apparatus that uses photomasks is that the maskless exposure apparatus 2-1 can correct (or transform) the exposure data in real time, that is, the maskless exposure apparatus 2-1 has an auto scaling function. However, if the wiring pattern to be drawn is a simple pattern, there may be no need to use the auto scaling function. In this case, if the same fee were billed to the user as when the auto scaling function was used, it would be unfair to the user. Accordingly, in the present embodiment, whether or not the exposure data has been generated by correcting the layout design data in real time during the exposure operation of the exposure apparatus, that is, by executing the auto scaling function, is adopted as a billing parameter. For convenience, this billing parameter is denoted by B1 in this patent specification. That is, when the auto scaling function was used, the manufactured product can be considered as having a high added value; therefore, a higher billing unit is set than when the auto scaling function was not used. Here, as the bitmap data generating software 21 in the data processing computer 20 can determine whether the auto scaling function has been used or not, information indicating the use or nonuse of the auto scaling function should be included in the header of the bitmap data to be sent to the data generation board 30.

The maskless exposure apparatus can be used to generate exposure data only for adjustment purposes and not for an actual exposure operation. Billing a charge for such exposure data generation for adjustment purposes would be unfair to the user. Accordingly, in the present embodiment, when exposure data is generated solely for adjustment purposes and not for an actual exposure operation, the billing charge calculation is stopped and the billing charge is not determined. That is, in this case, the number of frames counted by the counting means 11 is disregarded. For convenience, this billing parameter is denoted by B2 in this patent specification. For example, when the purpose of the exposure data generation is to verify the correctness of the exposure data generated by the exposure data generating means 10-1, there is no need to turn on the laser diodes of the laser light source unit 40 in the first place. Therefore, by monitoring the on/off states of the laser diodes, that is, by monitoring the driving state of the laser diode driving circuits 41 via the communication means 43, it can be determined whether the actual exposure operation has been performed or not.

To summarize the various billing parameters described above, the calculation of the billing charge M by the billing charge calculating means 33 is expressed by the function shown in equation (3) below.
M=M(F, L, W, Fmax, r, α, B1, B2) (3)

The above billing parameters need not all be adopted, but an appropriate one or more may be selected according to such factors as the use of the maskless exposure apparatus and the contract with the user. Further, the above billing parameters are only examples, and other billing parameters may be adopted. For example, the billing scheme may be set so that discounts are offered to users who use more than one maskless exposure apparatus or to users who are educational organizations or governmental research institutions; furthermore, long-term user discounts may be offered to long-term users. Alternatively, the billing scheme may be set so as to give a free dividend (point program like a mileage program) according to the period of use of the maskless exposure apparatus. The billing scheme may also be set so as to bill a surcharge for use of special service.

The above-described billing parameters are stored in the memory 36 shown in FIG. 2. The recording of the billing parameters to the memory 36 is done under the control of the data processing computer 20 or the main computer 4 via the communication means 22 and 35.

The billing charge calculating means 33 calculates the billing charge based on the equation (2) by considering the number of frames and, if necessary, also considering the billing parameters.

The billing charge calculated by the billing charge calculating means 33 is stored in the nonvolatile memory 34 together with the time of day of the calculation. By also recording the time of day of the calculation in this manner, it becomes possible, for example, to implement periodic billing. The billing charge data stored in the nonvolatile memory 34 is periodically sent to the data processing computer 20 via the communication means 22 and 35.

In addition to the billing based on the number of exposure data frames and the billing that considers the billing parameters, billing may also be done based on the operating records of the laser light source unit 40. In this case, the light energy produced by each laser diode is recorded, and information concerning the recorded light energy is stored as nonvolatile information, in the nonvolatile memory 42, together with the time of day of the recording.

The information stored in the nonvolatile memory 42 is sent to the memory 36 via the communication means 43. The billing charge calculating means 33 can then calculate the billing charge by considering the operating record of the laser diodes stored in the memory 36 to be a billing parameter. The billing charge P based on the operating records of the laser diodes is expressed by the function shown in equation (4) below.
P=P(p1, p2, p3, . . . , pn) (4)
where p1, p2, p3, . . . , pn respectively represent the amounts of light energy (watts×time) produced by n laser diodes constituting the laser light source unit 40.

Further, as the operating records of each laser diode can be kept track of, as described above, the records may also be used to predict the remaining life of each laser diode. In this case, information concerning the operating records of each laser diode is sent via the communication means 22 and 43 to the data processing computer 20 which then performs the calculation for the prediction. As a result, a replacement for the laser diode can be ordered at an appropriate time, which serves not only to minimize the risk of the production line stopping due to the failure of the laser diode for the user of the maskless exposure apparatus 2-1, but also to reduce the stock of replacements at the vendor (manufacturer) of the maskless exposure apparatus 2-1.

The billing charge calculated by the billing charge calculating means 33 is stored in the nonvolatile memory 34 together with the time of day of the calculation. By also recording the time of day of the calculation in this manner, it becomes possible to implement periodic billing. The billing charge data stored in the nonvolatile memory 34 is periodically sent to the data processing computer 20 via the communication means 22 and 35. Thus, billing can be done in accordance with the billing charge data, based on the contract with the user. Here, the definitions of the functions shown in the equations (3) and (4) above may be changed for each user based on the contract with the user.

The billing data sent by the data processing computer 20 may further be transmitted to the external main computer 4 via the Internet, a wireless link, or a telephone line or the like. For example, when a plurality of maskless exposure apparatus 2-1 are installed, a plurality of data processing computers 20 corresponding in number to the exposure apparatus are also provided; in this case, if the plurality of data processing computers 20 are connected to the single main computer 4 to be able to communicate with it, it becomes possible, for example, to totalize the billing charge data for each maskless exposure apparatus. Further, if the main computer 4 is placed, for example, under management of the manufacturer (vendor) of the maskless exposure apparatus 2-1 or its agent responsible for the billing operations, monitoring and billing from a remote site can be done easily, and also, lease management, of the maskless exposure apparatus, can be performed efficiently.

The above embodiment has been described for the maskless exposure apparatus, but it will be recognized that exactly the same principle can also apply to a direct drawing apparatus which comprises a plurality of drawing heads arranged at prescribed spacing and which draws a pattern directly on a drawing target moving relative to the drawing heads. Examples of such direct drawing apparatus include inkjet drawing apparatus and printing apparatus such as a laser printer.

Of these apparatus, the inkjet drawing apparatus which uses inkjet technology comprises a plurality of inkjet nozzles arranged at prescribed design spacing within an inkjet head, and draws a pattern directly on a drawing target substrate by ejecting conducting paste from the inkjet head while the substrate is moving relative to the inkjet head.

Inkjet technology is a technology that ejects liquid droplets through nozzles in which microscopic holes are formed. Generally, the inkjet technology is used for printers, but when applying the inkjet technology to inkjet patterning on a wiring substrate, the liquid droplets to be ejected from the nozzles should be replaced by a liquid containing fine metal particles or by conductive paste such as a metal oxide material. The inkjet technology can be classified into two main types: one is the piezoelectric type that utilizes a piezoelectric element which, when a voltage is applied, is caused to deform, causing a sudden increase in the liquid pressure in the ink chamber and thereby forcing a liquid droplet through the nozzle, and the other is the thermal type that forms a bubble in the liquid by a heater mounted on the head and thereby pushes out a liquid droplet. Either type can be used in the present invention.

When applying the present invention to the inkjet drawing apparatus, each exposure head in the above-described embodiment of the present invention should be replaced by an inkjet head. That is, the amount of conductive paste ejected from each inkjet head is recorded, and information concerning the recorded amount of conductive paste is stored as nonvolatile memory in the nonvolatile memory 42 together with the time of day of the recording. The billing charge calculating means 33 can then calculate the billing charge based not only on the number of frames but also on the amount of conductive paste, ejected from each inkjet head, that has been obtained from the nonvolatile information. Furthermore, based on the nonvolatile information, it is also possible to predict the time at which to replenish the inkjet head with the conductive paste.

The invention described above can be applied as a billing apparatus for a direct drawing apparatus in which drawing data generated based on layout design data and necessary for drawing is supplied to a drawing engine in real time during the drawing and, based on the drawing data, the drawing engine forms a drawing pattern on a drawing target moving relative to the drawing engine. The present invention can be applied whether the direct drawing apparatus is a maskless exposure apparatus or an inkjet drawing apparatus.

According to the present invention, as the user need not purchase the expensive direct drawing apparatus, but leases it from the vendor, the possibility of the direct drawing apparatus achieving widespread use in the semiconductor industry further increases, and eventually, the price of the direct drawing apparatus itself will be reduced because of the economies of volume production. Furthermore, the cost competitiveness of the product also increases. In particular, according to the present invention, as the appropriate billing scheme can be constructed easily, not only can the initial investment cost of the direct drawing apparatus be minimized, but also the vendor of the direct drawing apparatus can collect bills without fail.

On the other hand, the user does not have to outlay a large amount of money to purchase the direct drawing apparatus, but can install the apparatus at a minimum initial cost. This also serves to increase the cost competitiveness of the products manufactured using the direct drawing apparatus.

Furthermore, the billing charge can be determined according to the design rule, positional accuracy, etc. of the drawing pattern, and higher-rate billing plans can be set, for example, for drawing operations performed to manufacture higher value-added products; as a result, the user of the direct drawing apparatus can reasonably transfer the accrued production costs to the product price.

Further, by predicting the remaining life of each drawing device, a replacement for the expensive drawing device can be ordered at an optimum time; as a result, for the user of the direct drawing apparatus, the risk of the production line stopping due to the failure of the drawing device can be minimized and, for the vendor (manufacturer) of the direct drawing apparatus, the stock of replacements can be reduced.

According to the direct drawing apparatus, the design, inspection, and formation of high-precision wiring can be accomplished easily and at high speed, and also, the margin necessary for pattern alignment can be reduced, which serves to increase the wiring density. Accordingly, the invention can fully address the need for superfine wiring expected in the future. A further advantage is that, by processing the design data as needed and accumulating the correction information, the present invention can perform corrections and routing dynamically and can thus cope with design changes flexibly. The user can enjoy such benefits without investing a large amount of money.

What is claimed is:

1. A billing apparatus for a direct drawing apparatus in which drawing data generated based on layout design data and necessary for drawing is supplied to a drawing engine in real time during said drawing and, based on said drawing data, said drawing engine forms a drawing pattern on a drawing target moving relative to said drawing engine, said billing apparatus comprising:
counting means for counting the number of frames in said drawing data supplied to said drawing engine, one drawing data frame being constructed by packetizing data of an amount necessary for a drawing head in said drawing engine to perform one drawing operation; and
billing charge determining means for determining a billing charge based on said number of frames counted by said counting means.

2. A billing apparatus as claimed in claim 1, wherein said number of frames is determined by dividing a distance over which said drawing is to be performed on said drawing target along the direction of said relative movement, by a step size which defines a distance over which said drawing engine moves relative to said drawing target while said drawing engine performs one drawing operation using said drawing head.

3. A billing apparatus as claimed in claim 2, wherein said step size is dependent on bitmap resolution in said layout design data.

4. A billing apparatus as claimed in claim 1, wherein said billing charge determining means determines said billing charge based not only on said number of frames but also on a frame rate which is the speed at which said drawing data is supplied to said drawing engine.

5. A billing apparatus as claimed in claim 1, wherein said billing charge determining means determines said billing charge based not only on said number of frames but also on a width with which each drawing engine can perform drawing and which is measured in a direction orthogonal to the direction of relative movement of said drawing target.

6. A billing apparatus as claimed in claim 1, wherein said billing charge determining means determines said billing charge based not only on said number of frames but also on whether or not said layout design data has been corrected in real time during said drawing performed by said direct drawing apparatus.

7. A billing apparatus as claimed in claim 1, wherein said billing charge determining means adds a prescribed surcharge to said billing charge determined based on said number of frames.

8. A billing apparatus as claimed in claim 1, wherein said billing charge determining means deducts a prescribed discount, from said billing charge, determined based on said number of frames.

9. A billing apparatus as claimed in claim 1, wherein said billing charge determining means comprises:
determining means for determining whether or not said drawing engine has actually performed drawing based on said generated drawing data; and
stopping means for stopping determining said billing charge if it is determined by said determining means that said drawing has not been performed.

10. A billing apparatus as claimed in claim 9, wherein said direct drawing apparatus is a maskless exposure apparatus which forms a desired exposure pattern by projecting light from a plurality of exposure devices onto desired spots on an exposure target substrate moving relative to said exposure devices, said plurality of exposure devices being arranged along the direction of said relative movement, and wherein
by monitoring on/off states of said exposure devices, said determining means determines whether or not said exposure engine has actually performed said drawing.

11. A billing apparatus as claimed in claim 1, wherein said direct drawing apparatus is a maskless exposure apparatus which forms a desired exposure pattern by projecting light from a plurality of exposure devices onto desired spots on an exposure target substrate moving relative to said exposure devices, said plurality of exposure devices being arranged along the direction of said relative movement, said billing apparatus further comprising:
storing means for recording the amount of light energy produced during maskless exposure for each of said exposure devices, and for storing information concerning the amount of said light energy as nonvolatile information; and
predicting means for predicting the remaining life of each laser diode of said exposure devices based on said nonvolatile information.

12. A billing apparatus as claimed in claim 1, wherein said direct drawing apparatus is a maskless exposure apparatus which forms a desired exposure pattern by projecting light from a plurality of exposure devices onto desired spots on an exposure target substrate moving relative to said exposure devices, said plurality of exposure devices being arranged along the direction of said relative movement, said billing apparatus further comprising:
storing means for storing information concerning the amount of light energy produced during maskless exposure as nonvolatile information, and wherein
said billing charge determining means determines said billing charge based not only on said number of frames but also on operating records of said exposure devices that have been obtained from said nonvolatile information.

13. A billing apparatus as claimed in claim 1, wherein said direct drawing apparatus is an inkjet direct drawing apparatus which forms a desired drawn pattern by ejecting conducting paste from a plurality of inkjet heads onto desired spots on a drawing target substrate moving relative to said inkjet heads, said plurality of inkjet heads being arranged along the direction of said relative movement, said billing apparatus further comprising:
storing means for recording for each of said inkjet heads the amount of said conducting paste ejected from said inkjet head, and for storing information concerning the amount of said conducting paste as nonvolatile information; and
predicting means for predicting based on said nonvolatile information the time at which to replenish said each inkjet head with said conductive paste.

14. A billing apparatus as claimed in claim 1, wherein said direct drawing apparatus is an inkjet direct drawing apparatus which forms a desired drawing pattern by ejecting conducting paste from a plurality of inkjet heads onto desired spots on a drawing target substrate moving relative to said inkjet heads, said plurality of inkjet heads being arranged along the direction of said relative movement, said billing apparatus further comprising:
storing means for storing information concerning the amount of said conducting paste ejected from said inkjet heads as nonvolatile information, and wherein
said billing charge determining means determines said billing charge based not only on said number of frames but also on the amount of said conductive paste ejected, from said inkjet heads, that has been obtained from said nonvolatile information.

15. A billing apparatus for a plurality of said direct drawing apparatus as claimed in claim 1, wherein
said counting means and said billing charge determining means are provided for each of said plurality of direct drawing apparatus, and wherein
said billing apparatus further comprises totalizing means for totalizing said billing charge determined for each direct exposure apparatus by said billing charge determining means.
